(19) United States
(12) Patent Application Publication
(10) Pub. No.: US 2025/0162555 A1
(43) Pub. Date: May 22, 2025

(54) ELECTRONIC BRAKE SYSTEM AND OPERATING METHOD THEREOF

(71) Applicant: HL MANDO CORPORATION, Pyeongtaek-si, Gyeonggi-do (KR)

(72) Inventor: Seokjong KIM, Hwaseong-si (KR)

(73) Assignee: HL MANDO CORPORATION, Pyeongtaek-si, Gyeonggi-do (KR)

(21) Appl. No.: 18/842,005

(22) PCT Filed: Mar. 10, 2023
(86) PCT No.: PCT/KR2023/003291

§ 371 Date: Aug. 27, 2024

(30) Foreign Application Priority Data
Mar. 14, 2022 (KR) 10-2022-0031232

(51) Int. Cl. B60T 13/14; B60T 8/171; B60T 8/172; B60T 13/68; B60T 13/74; B60T 17/18

(52) U.S. Cl. CPC B60T 13/148; B60T 8/171; B60T 8/172; B60T 13/686; B60T 13/745; B60T 17/18; B60T 2220/04; B60T 2270/402; B60T 2270/404; B60T 2270/82

(57) ABSTRACT

An electronic brake system and an operating method thereof are disclosed. Provided is an electronic brake system, according to the present embodiment, comprising: a first hydraulic pressure supply device for generating hydraulic pressure by means of an electric signal output in response to the displacement of a brake pedal; an oil pressure control unit including a first oil pressure circuit for controlling the hydraulic pressure of a first wheel cylinder and a second wheel cylinder, and a second oil pressure circuit for controlling the hydraulic pressure of a third wheel cylinder and a fourth wheel cylinder; and a second hydraulic pressure supply device which is connected between the first oil pressure circuit and the first and second wheel cylinders, and which generates hydraulic pressure by means of an electric signal if the first hydraulic pressure supply device and/or the oil pressure control unit malfunctions.

### TECHNICAL FIELD

The present disclosure relates to an electronic brake system and an operating method thereof, and more particularly, to an electronic brake system and an operating method thereof which generate braking force by using an electric signal corresponding to a displacement of a brake pedal.

### BACKGROUND ART

A brake system for performing braking is requisitely mounted on a vehicle, and various types of brake systems are proposed for the safety of drivers and passengers.

A brake system in related art primarily adopts a scheme of supplying hydraulic pressure required for braking to a wheel cylinder through a mechanically connected booster when the driver steps on a brake pedal. However, as a market demand for implementing various braking functions specifically in response to an operating environment of the vehicles increases, recently, an electronic brake system has been widely distributed which receives a driver's braking intention as an electric signal from a pedal displacement sensor for detecting a displacement of a brake pedal when the driver steps on the brake pedal and supplies hydraulic pressure required for braking by operating a first hydraulic pressure supply device based thereon.

When such an electronic brake system operates in a normal operation mode, the operation of the brake pedal by the driver is generated and provided as the electric signal, and based thereon, the first hydraulic pressure supply device is electrically operated and controlled, so the hydraulic pressure required for braking is formed and transmitted to a wheel cylinder. As such, although such an electronic brake system and an operating method thereof are electrically operated and controlled so that complex and various braking operations may be implemented, when a technical problem occurs in an electric component, the hydraulic pressure required for braking is not stably formed, and as a result, there is a risk of threatening the safety of the passenger.

Therefore, the electronic brake system enters an abnormal operation mode when a component fails or becomes out of control, and in this case, a mechanism is required in which the operation of the brake pedal by the driver is directly linked to the wheel cylinders. That is, in the abnormal operation mode in the electronic brake system, as the driver applies a pedal effort to the brake pedal, a hydraulic pressure required for braking needs to be formed immediately and transmitted directly to the wheel cylinders.

### DISCLOSURE

### Technical Problem

An object to be achieved by the exemplary embodiment of the present disclosure is to provide an electronic brake system and an operating method thereof which may effectively implement braking even in various operation situations.

Another object to be achieved by the exemplary embodiment of the present disclosure is to provide an electronic brake system and an operating method thereof with improved performance and operation reliability.

Yet another object to be achieved by the exemplary embodiment of the present disclosure is to provide an electronic brake system and an operating method thereof which may stably generate and transmit braking pressure even in emergencies such as failures of various components, etc.

### Technical Solution

According to an aspect of the present disclosure, an electronic brake system may be provided, which includes: a first hydraulic pressure supply device for generating hydraulic pressure by means of an electric signal output in response to the displacement of a brake pedal; an oil pressure control unit including a first oil pressure circuit for controlling the hydraulic pressure of a first wheel cylinder and a second wheel cylinder, and a second oil pressure circuit for controlling the hydraulic pressure of a third wheel cylinder and a fourth wheel cylinder; a second hydraulic pressure supply device which is connected between the first oil pressure circuit and the first and second wheel cylinders, and which generates hydraulic pressure by means of the electric signal if at least any one of the first hydraulic pressure supply device and the oil pressure control unit malfunctions; a main hydraulic path connecting the first hydraulic pressure supply device and the oil pressure control unit; and a main isolation valve provided in the main hydraulic path and controlling a flow of a pressurized medium, but closed in a first fallback mode in which the first hydraulic pressure supply device malfunctions and the oil pressure control unit is enabled to operate normally to prevent the hydraulic pressure of the pressurized medium provided from the second hydraulic pressure supply device from leaking to the first hydraulic pressure supply device.

The first oil pressure circuit may include first and second inlet paths branched and connected to the first and second wheel cylinders, respectively, from a downstream of the main hydraulic path, and first and second inlet valves provided in the first and second inlet paths, respectively, and controlling the flow of the pressurized medium, and the second hydraulic pressure supply device may be connected to at least any one of the first inlet path and the second inlet path.

The second oil pressure circuit may include third and fourth inlet paths branched and connected to the third and fourth wheel cylinders, respectively, from the downstream of the main hydraulic path, and third and fourth inlet valves provided in the third and fourth inlet paths, respectively, and controlling the flow of the pressurized medium, and the first to fourth inlet valves may be opened in the first fallback mode to transmit the hydraulic pressure of the pressurized medium provided from the second hydraulic pressure supply device to all of the first to fourth wheel cylinders.

The electronic brake system may be provided to further include a support path connecting at least any one of the first inlet path and the second inlet path, and the second hydraulic pressure supply device; and a sub isolation valve provided in at least any one of the first inlet path and the second inlet path, but closed in a second fallback mode in which the oil pressure control unit malfunctions to prevent the hydraulic pressure of the pressurized medium provided from the second hydraulic pressure supply device from leaking to the oil pressure control unit.

The electronic brake system may be provided to further include: a first support path connecting the second hydraulic pressure supply device and the first inlet path; a second support path connecting the second hydraulic pressure supply device and the second inlet path; a first sub isolation valve provided between a point where the first support path is joined on the first inlet path, and the first inlet valve, and controlling the flow of the pressurized medium, but closed in a second fallback mode in which the oil pressure control unit malfunctions to prevent the hydraulic pressure of the pressurized medium provided from the second hydraulic pressure supply device from leaking to the oil pressure control unit; and a second sub isolation valve provided between a point where the second support path is joined on the second inlet path, and the second inlet valve, and controlling the flow of the pressurized medium, but closed in the second fallback mode to prevent the hydraulic pressure of the pressurized medium provided from the second hydraulic pressure supply device from leaking to the oil pressure control unit.

The electronic brake system may be provided to further include: a first support valve provided in the first support path and controlling the flow of the pressurized medium; and a second support valve provided in the second support path and controlling the flow of the pressurized medium.

The electronic brake system may be provided to further include a reservoir storing a pressurized medium, and the first oil pressure circuit may further include first and second outlet paths connecting the first and second wheel cylinders, and the reservoir, respectively, and first and second outlet valves provided in the first and second outlet paths, respectively, and controlling the flow of the pressurized medium, and the second oil pressure circuit may further include third and fourth outlet paths connecting the third and fourth wheel cylinders, and the reservoir, respectively, and third and fourth outlet valves provided in the third and fourth outlet paths, respectively, and controlling the flow of the pressurized medium.

The electronic brake system may be provided to further include: a reservoir storing a pressurized medium; a first dump path connecting the first wheel cylinder and the reservoir; and a second dump path connecting the second wheel cylinder and the reservoir.

The electronic brake system may be provided to further include: a first discharge valve provided in the first dump path and controlling the flow of the pressurized medium; and a second discharge valve provided in the second dump path and controlling the flow of the pressurized medium.

The electronic brake system may be provided to further include a first electronic control unit controlling an operation of at least any one of the first hydraulic pressure supply device, the oil pressure control unit, and the main isolation valve.

The electronic brake system may be provided to further include a second electronic control unit controlling an operation of at least any one of the second hydraulic pressure supply device, the oil pressure control unit, the main isolation valve, the first and second sub isolation valves, the first and second support valves, and the first and second discharge valves.

According to another aspect of the present disclosure, an operating method of an electronic brake system including a first hydraulic pressure supply device generating hydraulic pressure by means of an electric signal output in response to a displacement of a brake pedal, an oil pressure control unit controlling each of hydraulic pressures of first to fourth wheel cylinders, and a second hydraulic pressure supply device generating the hydraulic pressure by means of the electric signal when at least any one of the first hydraulic pressure supply device and the oil pressure control unit malfunctions, and connected to at least any one of the first to fourth wheel cylinders may be provided, which includes: a first fallback mode in which the first hydraulic pressure supply device malfunctions, but the oil pressure control unit is enabled to operate normally, in which in the first fallback mode, a main isolation valve provided in a main hydraulic path connecting the first hydraulic pressure supply device and the oil pressure control unit, and controlling a flow of a pressurized medium is closed to prevent hydraulic pressure of a pressurized medium provided from the second hydraulic pressure supply device from leaking to the first hydraulic pressure supply device.

The oil pressure control unit may include a first oil pressure circuit controlling hydraulic pressure of a first wheel cylinder and a second wheel cylinder and a second oil pressure circuit controlling hydraulic pressure of a third wheel cylinder and a fourth wheel cylinder, and in the first fallback mode, the hydraulic pressure of the pressurized medium provided from the second hydraulic pressure supply device may be transmitted to all of the first to fourth wheel cylinders.

The first oil pressure circuit may include first and second inlet paths branched and connected to the first and second wheel cylinders, respectively, from a downstream of the main hydraulic path, and first and second inlet valves provided in the first and second inlet paths, respectively, and controlling the flow of the pressurized medium, and the second hydraulic pressure supply device may be connected to at least any one of the first inlet path and the second inlet path, and transmitting the hydraulic pressure of the pressurized medium.

The second oil pressure circuit may include third and fourth inlet paths branched and connected to the third and fourth wheel cylinders, respectively, from the downstream of the main hydraulic path, and third and fourth inlet valves provided in the third and fourth inlet paths, respectively, and controlling the flow of the pressurized medium, and in the first fallback mode, the first to fourth inlet valves may be opened to transmit the hydraulic pressure of the pressurized medium provided from the second hydraulic pressure supply device to all of the first to fourth wheel cylinders.

The operating method of an electronic brake system may further include, in which a sub isolation valve may be provided in at least any one of the first inlet path and the second inlet path, a second fallback mode in which the oil pressure control unit malfunctions, and in the second fallback mode, the sub isolation valve may be closed to prevent the hydraulic pressure of the pressurized medium provided from the second hydraulic pressure supply device from leaking to the oil pressure control unit.

The operating method of an electronic brake system may further include, in which a first sub isolation valve may be provided between a point where the second hydraulic pressure supply device is connected on the first inlet path, and the first inlet valve, and a second sub isolation valve is provided between a point where the second hydraulic pressure supply device is connected on the second inlet path, and the second inlet valve, a second fallback mode in which the oil pressure control unit malfunctions, and in the second fallback mode, the first and second sub isolation valves may be closed to prevent the hydraulic pressure of the pressurized medium provided from the second hydraulic pressure supply device from leaking to the oil pressure control unit.

A first support valve may be provided in a first support path connecting the second hydraulic pressure supply device and the first inlet path, and a second support valve may be provided in a second support path connecting the second hydraulic pressure supply device and the second inlet path, and in the first and second fallback modes, the first and second support valves may be opened to allow the flow of the pressurized medium provided from the second hydraulic pressure supply device.

The operating method of an electronic brake system may further include a normal mode in which both the first hydraulic pressure supply device and the oil pressure control unit are enabled to operate normally, and in the normal mode, the first and second sub isolation valves may be opened to transmit the hydraulic pressure of the pressurized medium provided from the first hydraulic pressure supply device to the first and second wheel cylinders.

In the normal mode, the first and second support valves may be closed to prevent the hydraulic pressure of the pressurized medium provided from the first hydraulic pressure supply device from leaking to the second hydraulic pressure supply device.

### Advantageous Effects

In the electronic brake system and the operating method thereof according to the exemplary embodiments of the present disclosure, braking can be stably and effectively implemented in various operation situations of a vehicle.

In the electronic brake system and the operating method thereof according to the exemplary embodiments of the present disclosure, the performance and operation reliability of a product can be enhanced.

In the electronic brake system and the operating method thereof according to the exemplary embodiments of the present disclosure, braking pressure can be stably provided even when a component fails.

### DESCRIPTION OF DRAWINGS

FIG. 1 is an oil pressure circuit diagram illustrating an electronic brake system according to an exemplary embodiment of the present disclosure.

FIG. 2 is an oil pressure circuit diagram illustrating a state in which an electronic brake system performs a normal mode according to an exemplary embodiment of the present disclosure.

FIG. 3 is an oil pressure circuit diagram illustrating a state in which the electronic brake system performs a first fallback mode according to an exemplary embodiment of the present disclosure.

FIG. 4 is an oil pressure circuit diagram illustrating a state in which the electronic brake system performs active braking in the first fallback mode according to an exemplary embodiment of the present disclosure.

FIG. 5 is an oil pressure circuit diagram illustrating a state in which the electronic brake system performs a second fallback mode according to an exemplary embodiment of the present disclosure.

### MODE FOR INVENTION

Hereinafter, exemplary embodiments of the present disclosure will be described in detail with reference to the accompanying drawings. The following exemplary embodiment is to present the idea of the present disclosure to those skilled in the art to which the present disclosure pertains. The present disclosure is not limited to exemplary embodiments described presented herein and may be embodied in other forms. In the drawings, illustration of parts not related to the description may be omitted to clarify the present disclosure, and the size of a component may be slightly exaggerated and expressed to help understanding.

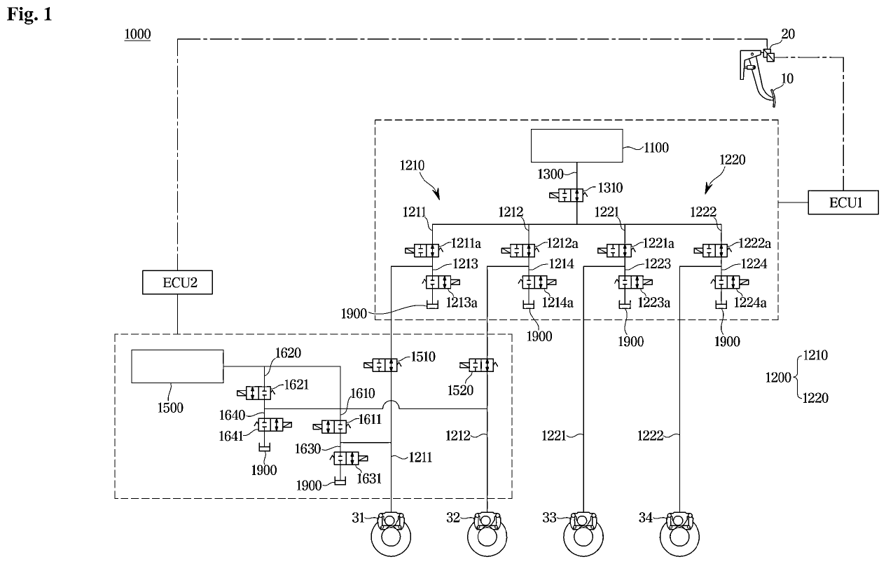

FIG. 1 is an oil pressure circuit diagram illustrating an electronic brake system 1000 according to an exemplary embodiment of the present disclosure.

Referring to FIG. 1, the electronic brake system 1000 according to the exemplary embodiment of the present disclosure includes a first hydraulic pressure supply device 1100 which receives a braking intention of a driver by a pedal displacement sensor 20 that detects a displacement of a brake pedal 10 therein as an electric signal, and generates hydraulic pressure of a pressurized medium through an electromechanical operation, an oil pressure control unit 1200 which controls hydraulic pressure transmitted to wheel cylinders 31, 32, 33, and 34, a main hydraulic path 1300 which connects the first hydraulic pressure supply device 1100 and the oil pressure control unit 1200, a main isolation valve 1310 which is provided in the main hydraulic path 1300 and which controls a flow of the pressurized medium, a second hydraulic pressure supply device 1600 which receives the electric signal and generates the hydraulic pressure of the pressurized medium when at least any one of the first hydraulic pressure supply device 1100 and the oil pressure control unit 1200 malfunctions, a reservoir 1900 storing a pressurized medium such as brake oil, and at least one electronic control unit ECU1 or ECU2 which controls an operation of each component based on hydraulic pressure information and pedal displacement information therein.

The first hydraulic pressure supply device 1100 is provided to receive the braking intention of the driver from the pedal displacement sensor 20 that detects the displacement of the brake pedal 10 as the electric signal, and generate the hydraulic pressure of the pressurized medium through the electromechanical operation based thereon.

As an example, the first hydraulic pressure supply device 1100 may be provided as a device that operates a hydraulic piston (not illustrated) based on the electric signal of the pedal displacement sensor 20, and pressurizes the pressurized medium accommodated in a pressure chamber by a displacement of the hydraulic piston to form the hydraulic pressure. Further, the first hydraulic pressure supply device 1100 may include the pressure chamber in each of a front and a rear of the hydraulic piston, and the hydraulic piston performs a reciprocating motion to form the hydraulic pressure of the pressurized medium through two pressure chambers. However, the second hydraulic pressure supply device 1100 is not limited to the corresponding device, and if the second hydraulic pressure supply device 1100 operates electromechanically to form the hydraulic pressure of the pressurized medium, it should be understood equally even when the second hydraulic pressure supply device 1100 is configured by devices of various structures and schemes.

The operation of the first hydraulic pressure supply device 1100 may be controlled by a first electronic control unit ECU1, and the first hydraulic pressure supply device 1100 operates in a normal mode which is a state of being capable of general and normal braking, to form the hydraulic pressure of the pressurized medium for braking a plurality of wheel cylinders 31, 32, 33, and 34, and provide the hydraulic pressure to the oil pressure control unit 1200 through the main hydraulic path 1300 to be described later.

Meanwhile, although not illustrated in the drawing, the brake pedal 10 is connected to a master cylinder or a pedal simulator, so that a reaction force according to a pedal effort of the brake pedal 10 is generated to provide a pedal feel to the driver.

The oil pressure control unit 1200 may be provided between the first hydraulic pressure supply device 1100, and the wheel cylinders 31, 32, 33, and 34, but the operation of the oil pressure control unit 1200 may be controlled by the first electronic control unit ECU1.

The oil pressure control unit 1200 may include a first oil pressure circuit 1210 controlling the flow of the hydraulic pressure transmitted to first and second wheel cylinders 31 and 32 among four wheel cylinders, and a second oil pressure circuit 1220 controlling the flow of the hydraulic pressure transmitted to third and fourth wheel cylinders 33 and 34, and includes multiple hydraulic paths and solenoid valves to control the hydraulic pressure applied to the wheel cylinders 31, 32, 33, and 34.

The first oil pressure circuit 1210 may control the hydraulic pressure of the first and second cylinders 31 and 32 which are two wheel cylinders among four vehicle wheels RR, RL, FR, and FL, and the second oil pressure circuit 1220 may control the hydraulic pressure of the third and fourth wheel cylinders 33 and 34 which are two other wheel cylinders 20.

The first and second oil pressure circuits 1210 and 1220 may include first to fourth inlet paths 1211, 1212, 1221, and 1222 branched and connected to the first to fourth wheel cylinders 31, 32, 33, and 34, respectively, from the main hydraulic path 1300 to be described later. The first to fourth inlet paths 1211, 1212, 1221, and 1222 may have upstream ends connected to each other, but may be connected to a downstream side of the main hydraulic path 1300, and downstream ends of the respective inlet paths 1211, 1212, 1221, and 1222 may be connected to the first to fourth wheel cylinders 31, 32, 33, and 34, respectively.

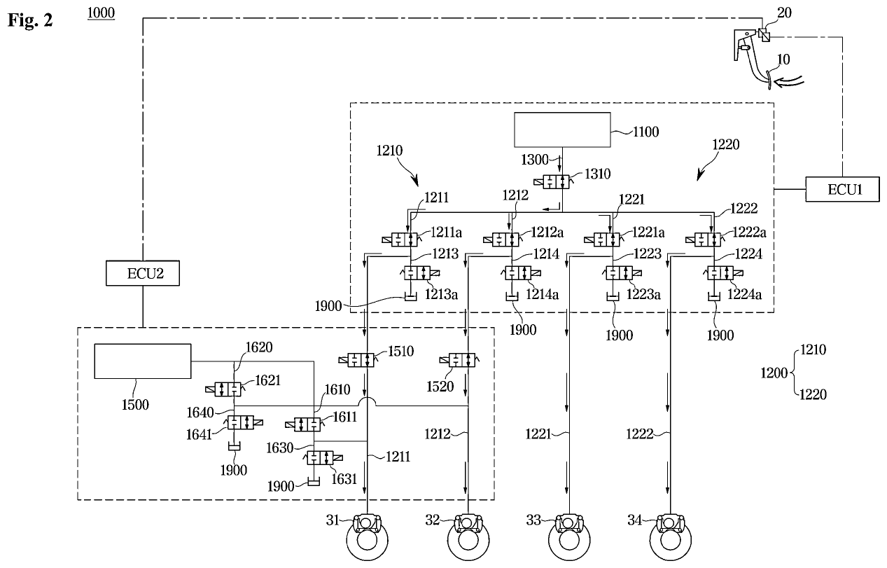

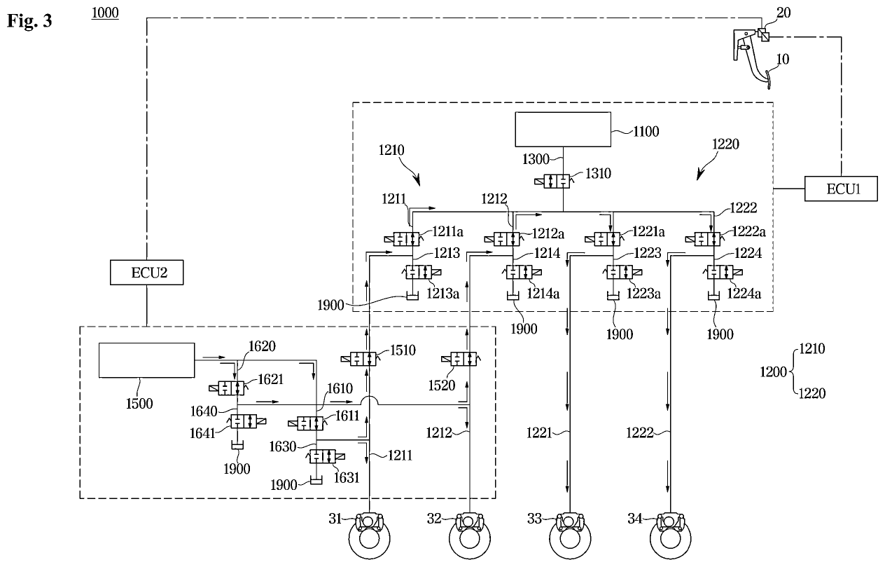

First to fourth inlet valves 1211a, 1212a, 1221a, and 1222a may be provided in the first to fourth inlet paths 1211, 1212, 1221, and 1222, respectively. The first to fourth inlet valves 1211a, 1212a, 1221a, and 1222a may control the flow of the pressurized media generated by the first hydraulic pressure supply device 1100 and transmitted to the respective wheel cylinders 31, 32, 33, and 34, and moreover, also control the flow of a pressurized medium generated by the second hydraulic pressure supply device 1500, and transmitted in the first fallback mode to be described later. The first to fourth inlet valves 1211a, 1212a, 1221a, and 1222a may be provided as normal open type solenoid valves in which valves operate to be opened at normal times and then to be closed upon receiving the electric signal from the first or second electronic control unit ECU1 or ECU2. The first to fourth inlet valves 1211a, 1212a, 1221a, and 1222a are controlled in an opened state in the normal mode which is a normal operation state to transmit the hydraulic pressure of the pressurized medium generated and provided by the first hydraulic pressure supply device 1100 to the oil pressure control unit 1200, and are also opened in the first fallback mode in which the first hydraulic pressure supply device 1100 is disabled to operate normally, but the oil pressure control unit 1200 is enabled to operate normally, so that the hydraulic pressure of the pressurized medium provided by the second hydraulic pressure supply device 1500 may be all provided to the first to fourth wheel cylinders 31, 32, 33, and 34. A detailed description thereof will be provided below with reference to FIGS. 2 and 3.

First and second support paths 1610 and 1620 to be described below may be joined and connected to the first and second inlet paths 1211 and 1212, respectively, and first and second sub isolation valves 1510 and 1520 to be described below may be provided on upstream sides of points where the first and second support paths 1610 and 1620 are joined, respectively. A detailed description thereof will be provided later.

Meanwhile, although not illustrated in the drawing, the first and second oil pressure circuits 1210 and 1220 may include first to fourth check valves which are provided to be connected to the first to fourth inlet valves 1211a, 1212a, 1221a, and 1222a in parallel, respectively. The first to fourth check valves may be provided in a bypass path connecting fronts and rears of the first to fourth inlet valves 1211a, 1212a, 1221a, and 1222a on the first to fourth inlet paths 1211, 1212, 1221, and 1222, and may allow only the flow of the pressurized medium discharged from each of the wheel cylinders 31, 32, 33, and 34, and block the flow of the pressurized medium heading to each of the wheel cylinders 31, 32, 33, and 34. The hydraulic pressure of the pressurized medium applied to each of the wheel cylinders 31, 32, 33, and 34 may be quickly extracted by the first to fourth check valves upon braking release, and even when the first to fourth inlet valves 1211a, 1212a, 1221a, and 1222a do not operate normally, the hydraulic pressure of the pressurized medium applied to the wheel cylinders 31, 32, 33, and 34 may be smoothly discharged.

The first and second oil pressure circuits 1210 and 1220 may further include first to fourth outlet paths 1213, 1214, 1223, and 1224 connected to the reservoir 1900 from the first to fourth wheel cylinders 31, 32, 33, and 34, respectively. The reservoir 1900 may accommodate a pressurized medium such as brake oil, etc., therein, and the first to fourth outlet paths 1213, 1214, 1223, and 1224 have upstream ends connected to the wheel cylinders 31, 32, 33, and 34, respectively, but downstream ends are connected to the reservoir 1900, so that the pressurized media applied to the respective wheel cylinder 31, 32, 33, and 34 may be discharged to the reservoir 1900 through the respective outlet paths 1213, 1214, 1223, and 1224 when braking is released.

First to fourth outlet valves 1213a, 1214a, 1223a, and 1224a may be provided in the first to fourth outlet paths 1213, 1214, 1223, and 1224, respectively. The first to fourth outlet valves 1213a, 1214a, 1223a, and 1224a may control the flow of the pressurized media discharged from the first to fourth wheel cylinders 31, 32, 33, and 34 to the reservoir 1900, and in particular, when performing active braking such as an anti-lock brake system (ABS) mode or a traction control system (TCS) mode, the hydraulic pressure of the pressurized medium applied to each of the wheel cylinder 31, 32, 33, and 34 may be individually reduced. The first to fourth outlet valves 1213a, 1214a, 1223a, and 1224a may be provided as normal closed type solenoid valves in which valves operate to be closed at normal times, and then to be opened upon receiving the electric signal from the first or second electronic control unit ECU1 or ECU2.

The main hydraulic path 1300 is provided to transmit the hydraulic pressure of the pressurized medium formed in the first hydraulic pressure supply device 1100 to the oil pressure control unit 1200. To this end, the main hydraulic path 1300 has an inlet end connected to the first hydraulic pressure supply device 1100, and an outlet end connected to the oil pressure control unit 1200, but may be branched and connected to the first to fourth inlet paths 1211, 1212, 1221, and 1222 toward the first to fourth wheel cylinders 31, 32, 33, and 34. The main hydraulic path 1300 may be provided with a main isolation valve 1310 that controls the flow of the pressurized medium. The main isolation valve 1310 may be provided as the normal open type solenoid valve in which the valve operates to be opened at normal times, and then to be closed upon receiving a close signal from the electronic control unit. The main isolation valve 1310 is controlled in an opened state in the normal mode which is a normal operation state to transmit the hydraulic pressure of the pressurized medium generated and provided by the first hydraulic pressure supply device 1100 to the oil pressure control unit 1200, and is closed in the first fallback mode in which the first hydraulic pressure supply device 1100 is disabled to operate normally, but the oil pressure control unit 1200 is enabled to operate normally to prevent the pressurized medium from leaking to the first hydraulic pressure supply device 1100. A detailed description thereof will be provided below with reference to FIGS. 2 to 4.

The second hydraulic pressure supply device 1500 is provided to be connected to any one of the first and second oil pressure circuits 1210 and 1220, but operates when at least any one of the first hydraulic pressure supply device 1100 and the oil pressure control unit 1200 malfunctions due to a failure, etc., to generate and provide required hydraulic pressure to at least any one of the first to fourth wheel cylinders 31, 32, 33, and 34. A state in which the first hydraulic pressure supply device 1100 malfunctions, but the oil pressure control unit 1200 is enabled to operate normally is referred to as the first fallback mode, and a state in which the oil pressure control unit 1200 malfunctions is referred to as a second fallback mode. Here, the second fallback mode includes a state in which both the oil pressure control unit 1200 and the first hydraulic pressure supply device 1100 malfunction.

Similar to the first hydraulic pressure supply device 1100, the second hydraulic pressure supply device 1500 may receive the braking intention of the driver from the pedal displacement sensor 20 that detects the displacement of the brake pedal 10 as the electric signal, and may generate the hydraulic pressure of the pressurized medium through the electromechanical operation based on the electric signal.

As an example, the second hydraulic pressure supply device 1500 may be provided as a device that operates a motor (not illustrated) by receiving power based on the electric signal of the pedal displacement sensor 20, and drives a pump (not illustrated) through the motor to form the hydraulic pressure of the pressurized medium. However, the second hydraulic pressure supply device 1500 is not limited to the corresponding device, and if the second hydraulic pressure supply device 1500 operates electromechanically to form the hydraulic pressure of the pressurized medium, the second hydraulic pressure supply device 1500 may be, of course, configured by devices of various structures and schemes.

The operation of the second hydraulic pressure supply device 1500 may be controlled by the second electronic control unit ECU2, and operate in the first and second fallback modes to provide hydraulic pressure for braking to at least any one of the plurality of wheel cylinders 31, 32, 33, and 34.

The first and second support paths 1610 and 1620 are provided to transmit the hydraulic pressure of the pressurized medium formed in the second hydraulic pressure supply device 1500 to the wheel cylinder. To this end, the inlet end of the first support path 1610 may be connected to the second hydraulic pressure supply device 1500, and the outlet end may be joined and connected to a downstream side of the first inlet valve 1211a on the first inlet path 1211. Further, the inlet end of the second support path 1620 may be connected to the second hydraulic pressure supply device 1500, and the outlet end may be joined and connected to a downstream side of the second inlet valve 1212a on the second inlet path 1212. However, the present disclosure is not limited thereto, and unlike what is illustrated in the drawing, the first and second support paths 1610 and 1620 may also be connected to the third and fourth inlet paths 1221 and 1222 of the second oil pressure circuit 1220.

The first and second sub isolation valves 1510 and 1520 are provided to prevent the hydraulic pressure of the pressurized medium formed by the second hydraulic pressure supply device 1500 from leaking to the oil pressure control unit 1200 in the second fallback mode. The first sub isolation valve 1510 may be provided between a point where the first support path 1610 is joined on the first inlet path 1211, and the first inlet valve 1211a, and the second sub isolation valve 1520 may be provided between a point where the second support path 1620 is joined on the second inlet path 1212, and the second inlet valve 1212a.

In the second fallback mode, since the oil pressure control unit 1200 is in a malfunctioning state due to the failure, etc., if the hydraulic pressure of the pressurized medium formed by the second hydraulic pressure supply device 1500 leaks to the oil pressure control unit 1200, there is a risk that controlling the hydraulic pressure for braking is not smooth. Accordingly, the first and second sub isolation valves 1510 and 1520 are opened in the normal mode and the first fallback mode, so that the hydraulic pressure of the pressurized medium formed by the first hydraulic pressure supply device 1100 or the second hydraulic pressure supply device 1500 is allowed to be transmitted to the wheel cylinder or the oil pressure control unit 1200, but the first and second sub isolation valves 1510 and 1520 are closed in the second fallback mode which is the malfunctioning state of the oil pressure control unit 1200 to prevent the hydraulic pressure of the pressurized medium formed by the second hydraulic pressure supply device 1500 from leaking to the oil pressure control unit 1200.

The first and second sub isolation valves 1510 and 1520 may be provided as the normal open type solenoid valves in which opening and closing operations may be controlled by the second electronic control unit ECU2, and the valves operate to be opened at normal times, and then to be closed upon receiving the electric signal from the second electronic control unit ECU2.

A first support valve 1611 controlling the flow of the pressurized medium provided to the first inlet path 1211 from the second hydraulic pressure supply device 1500 may be provided in the first support path 1610. The first support valve 1611 may be provided as the normal closed type solenoid valve in which the opening and closing operations may be controlled by the second electronic control unit ECU2, and the valve operates to be closed at normal times, and then to be opened upon receiving the electric signal from the second electronic control unit ECU2. When the second electronic control unit ECU2 is switched to the first or second fallback mode, the second electronic control unit ECU2 may open the first support valve 1611 so that the hydraulic pressure of the pressurized medium provided from the second hydraulic pressure supply device 1500 may be provided to the wheel cylinder.

A second support valve 1621 controlling the flow of the pressurized medium provided to the second inlet path 1212 from the second hydraulic pressure supply device 1500 may be provided in the second support path 1620. The second support valve 1621 may be provided as the normal closed type solenoid valve in which the opening and closing operations may be controlled by the second electronic control unit ECU2, and the valve operates to be closed at normal times, and then to be opened upon receiving the electric signal from the second electronic control unit ECU2. When the second electronic control unit ECU2 is switched to the first or second fallback mode, the second electronic control unit ECU2 may open the second support valve 1621 so that the hydraulic pressure of the pressurized medium provided from the second hydraulic pressure supply device 1500 may be provided to the wheel cylinder.

The pressurized medium applied to the first wheel cylinder 31 may be discharged to the reservoir 1900 through a first dump path 1630. To this end, one end of the first dump path 1630 may be connected to the first wheel cylinder 31 or a downstream side of the first support valve 1611 of the first support path 1610, and the other end may be connected to the reservoir 1900. A first discharge valve 1631 controlling the flow of the pressurized medium discharged from the first wheel cylinder 31 to the reservoir 1900 is provided in the first dump path 1630. The first discharge valve 1631 may be provided as the normal closed type solenoid valve in which the opening and closing operations may be controlled by the second electronic control unit ECU2, and the valve operates to be closed at normal times, and then to be opened upon receiving the electric signal from the second electronic control unit ECU2.

The pressurized medium applied to the second wheel cylinder 32 may be discharged to the reservoir 1900 through a second dump path 1640. To this end, one end of the second dump path 1640 may be connected to the second wheel cylinder 32 or a downstream side of the second support valve 1621 of the second support path 1620, and the other end may be connected to the reservoir 1900. A second discharge valve 1641 controlling the flow of the pressurized medium discharged from the second wheel cylinder 32 to the reservoir 1900 is provided in the second dump path 1640. The second discharge valve 1641 may be provided as the normal closed type solenoid valve in which the opening and closing operations may be controlled by the second electronic control unit ECU2, and the valve operates to be closed at normal times, and then to be opened upon receiving the electric signal from the second electronic control unit ECU2.

Hereinafter, an operation of the electronic brake system 1000 according to an exemplary embodiment of the present disclosure will be described.

The electronic brake system 1000 according to the exemplary embodiment of the present disclosure may perform a normal mode in which the electronic brake system 1000 operates normally without failures or errors of various devices and valves, a first fallback mode as a state in which the first hydraulic pressure supply device 1100 malfunctions, but the oil pressure control unit 1200 is enabled to operate normally, in which the second hydraulic pressure supply device 1500 intervenes to provide the hydraulic pressure of the pressurized medium to all of the first to fourth wheel cylinders 31, 32, 33, and 34, and a second fallback mode as a state in which the oil pressure control unit 1200 malfunctions, in which the second hydraulic pressure supply device 1500 intervenes to provide the hydraulic pressure of the pressurized medium to some wheel cylinders (the first and second wheel cylinders based on the drawing). At this time, the second fallback mode includes a case where both the first hydraulic pressure supply device 1100 and the oil pressure control unit 1200 malfunction in addition to a case where only the oil pressure control unit 1200 malfunctions.

First, the normal mode of the electronic brake system 1000 according to the exemplary embodiment of the present disclosure will be described.

FIG. 2 is an oil pressure circuit diagram illustrating a state in which an electronic brake system 1000 performs a normal mode according to an exemplary embodiment of the present disclosure. Referring to FIG. 2, when the electronic brake system 1000 operates normally, if the driver applies the pedal effort to the brake pedal 10, the first electronic control unit ECU1 operates the first hydraulic pressure supply device 1100 based on displacement information of the brake pedal 10 detected by the pedal displacement sensor 20.

The hydraulic piston of the first hydraulic pressure supply device 1100 moves forward or backward to form the hydraulic pressure of the pressurized medium, which is transmitted to the oil pressure control unit 1200 through the main hydraulic path 1300.

In the normal mode, since the first hydraulic pressure supply device 1100 operates normally, the main isolation valve 1310 maintains an opened state, so the hydraulic pressure generated by the first hydraulic pressure supply device 1100 may be transmitted to the oil pressure control unit 1200, and the second hydraulic pressure supply device 1500 does not operate. Further, the first and second sub isolation valves 1510 and 1520 maintain the opened state, so the hydraulic pressure provided by the first hydraulic pressure supply device 1100 may be smoothly supplied to the first to fourth wheel cylinders 21, 22, 23, and 24 through the first to fourth inlet paths 1211, 1212, 1221, and 1222. At this time, the first to fourth inlet valves 1211a, 1212a, 1221a, and 1222a maintain the opened state.

Further, in the normal mode, when active braking such as an ABS mode or a TCS mode is intended to be performed according to an operation situation of a vehicle, an outlet valve provided in a specific wheel cylinder which needs to be depressurized is controlled to be selectively opened, so at least a part of hydraulic pressure applied to the specific wheel cylinder may be discharged to the reservoir 1900 through an outlet path.

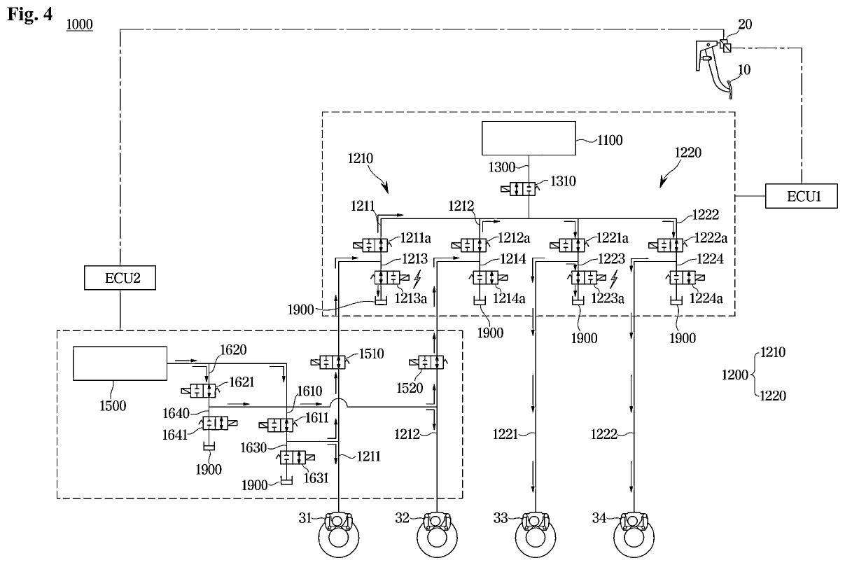

The electronic brake system 1000 according to the exemplary embodiment of the present disclosure may be switched to the first fallback mode illustrated in FIGS. 3 and 4 when the first hydraulic pressure supply device 1100 is in a malfunctioning state such as a failure, leakage of the pressurized medium, etc.

FIG. 3 is an oil pressure circuit diagram illustrating a state in which the electronic brake system 1000 performs a first fallback mode according to an exemplary embodiment of the present disclosure.

When the first electronic control unit ECU 1 determines that the first hydraulic pressure supply device 1100 is disabled to operate normally, but determines that the oil pressure control unit 1200 is enabled to operate normally, the first electric control unit ECU1 may enter the first fallback mode.

Referring to FIG. 3, when the driver applies the pedal effort to the brake pedal 10 in the first fallback mode, the second electronic control unit ECU2 operates and intervenes the second hydraulic pressure supply device 1500 based on displacement information of the brake pedal 10 detected by the pedal displacement sensor 20.

The motor or pump of the second hydraulic pressure supply device 1500 operates to form the hydraulic pressure of the pressurized medium, which is transmitted to the first oil pressure circuit 1210 via the first and second support paths 1610 and 1620. At this time, the first and second support valves 1611 and 1621 provided in the first and second support paths 1610 and 1620, respectively are switched to the opened state so that the hydraulic pressure of the pressurized medium provided from the second hydraulic pressure supply device 1550 is smoothly transmitted.

In the first fallback mode, the oil pressure control unit 1200 is in a state of being enabled to be opened/closed normally, so the second electronic control unit ECU2 controls to open the first and second sub isolation valves 1510 and 1520 to transmit the hydraulic pressure of the pressurized medium generated by the second hydraulic pressure supply device 1500, and supplied via the first and second support paths 1610 and 1620 to the oil pressure control unit 1200. At this time, when the hydraulic pressure of the pressurized medium provided from the second hydraulic pressure supply device 1500 leaks to the first hydraulic pressure supply device 1100, there is a risk that a piston or a sealing member is deformed or damaged due to the hydraulic pressure. Therefore, the first electronic control unit ECU1 or the second electronic control unit ECU2 closes the main isolation valve 1310 provided in the main hydraulic path 1300 so as to prevent the hydraulic pressure of the pressurized medium provided from the second hydraulic pressure supply device 1500 from leaking to the first hydraulic pressure supply device 1100.

Further, in the first fallback mode, the first electronic control unit ECU1 or the second electronic control unit ECU2 controls the first to fourth inlet valves 1211a, 1212a, 1221a, and 1222a in the opened state, so the hydraulic pressure of the pressurized medium provided from the second hydraulic pressure supply device 1500 via the first and second inlet paths 1211 and 1212 may be transmitted to the third and fourth inlet paths 1221 and 1222, and as a result, even when the second hydraulic pressure supply device 1500 intervenes in the first fallback mode, the hydraulic pressure of the pressurized medium is transmitted to all of the first to fourth wheel cylinders 31, 32, 33, and 34, thereby performing stable braking of the vehicle.

Meanwhile, the electronic brake system 1000 according to the exemplary embodiment of the present disclosure is provided to enable the active braking even in the first fallback mode in which the first hydraulic pressure supply device 1100 malfunctions.

FIG. 4 is an oil pressure circuit diagram illustrating a state in which the electronic brake system 100 performs active braking in the first fallback mode according to an exemplary embodiment of the present disclosure.

As described above, in the first fallback mode, the first to fourth inlet valves 1211a, 1212a, 1221a, and 1222a of the oil pressure control unit 1200 are provided in the opened state, so that despite the fallback mode which is an emergency operation state, the hydraulic pressure of the pressurized medium may be stably transmitted to all of the first to fourth wheel cylinders 31, 32, 33, and 34. At this time, when the active braking such as the ABS mode or the TCS mode is intended to be performed according to the operation situation of the vehicle, the second electronic control unit ECU2 may control to selectively open an outlet valve provided in a specific wheel cylinder which needs to be depressurized. As an example, as illustrated in FIG. 4, when selective depressurization of the first wheel cylinder 31 and the third wheel cylinder 33 is required for the active braking in the first fallback mode, the second electronic control unit ECU2 opens the first outlet valve 1213a and the third outlet valve 1223a to discharge at least a part of the hydraulic pressure of the pressurized medium applied to the first wheel cylinder 31 and the third wheel cylinder 33 to the reservoir 1900.

As such, the electronic brake system 1000 according to the exemplary embodiment of the present disclosure determines whether the oil pressure control unit 1200 is enabled to operate normally even in the fallback mode which is the emergency operation state and enters the first fallback mode, and thus transmits hydraulic pressure of the pressurized medium to all of the first to fourth wheel cylinders 31, 32, 33, and 34 rather than some wheel cylinders to implement stable braking of the vehicle. Moreover, although the first fallback mode is the emergency operation state, the active braking such as the ABS mode or the TCS mode may be performed through control of a specific outlet valve, thereby ensuring the safety of the driver and passengers in response to various operation situations of the vehicle.

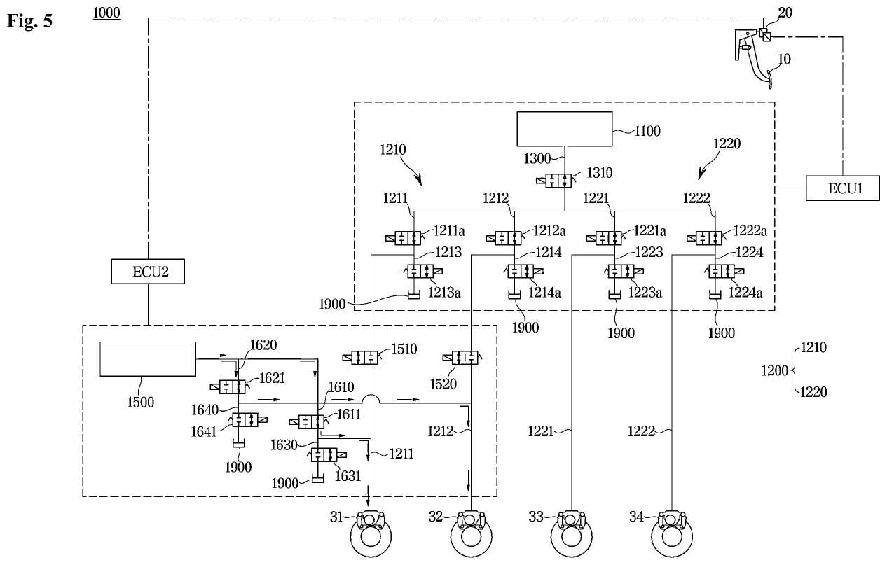

The electronic brake system 1000 according to the exemplary embodiment of the present disclosure may be switched to the second fallback mode illustrated in FIG. 5 when the oil pressure control unit 1200 is in the malfunctioning state such as the failure, the leakage of the pressurized medium, etc.

FIG. 5 is an oil pressure circuit diagram illustrating a state in which the electronic brake system 1000 performs a second fallback mode according to an exemplary embodiment of the present disclosure.

When the second electronic control unit ECU2 determines that the oil pressure control unit 1200 is in a state in which a normal operation is impossible, the second electronic control unit ECU2 may enter the second fallback mode.

Referring to FIG. 5, when the driver applies the pedal effort to the brake pedal 10 in the second fallback mode, the second electronic control unit ECU2 operates and intervenes the second hydraulic pressure supply device 1500 based on displacement information of the brake pedal 10 detected by the pedal displacement sensor 20.

The motor or pump of the second hydraulic pressure supply device 1500 operates to form the hydraulic pressure of the pressurized medium, which is transmitted to the first oil pressure circuit 1210 via the first and second support paths 1610 and 1620. At this time, the first and second support valves 1611 and 1621 provided in the first and second support paths 1610 and 1620, respectively are switched to the opened state so that the hydraulic pressure of the pressurized medium provided from the second hydraulic pressure supply device 1550 is smoothly transmitted. As a result, the hydraulic pressure of the pressurized medium provided from the second hydraulic pressure supply device 1500 sequentially passes through the first and second support paths 1610 and 1620 and the first and second inlet paths 1211 and 1212, and is transmitted to the first and second wheel cylinders 31 and 32 to perform emergency braking.

Meanwhile, in the second fallback mode, the hydraulic control unit 1200 is in a state in which normal opening and closing operation is impossible, so when the hydraulic pressure of the pressurized medium provided from the second hydraulic pressure supply device 1500 leaks to the oil pressure control unit 1200, there is a risk of occurrence of a safety accident due to delayed braking responsiveness of the vehicle due to poor hydraulic pressure control of the pressurized medium. Therefore, the first electronic control unit ECU1 or the second electronic control unit ECU2 controls to close the first and second sub isolation valves 1510 and 1520 in the second fallback mode to prevent the hydraulic pressure of the pressurized medium generated by the second hydraulic pressure supply device 1500 and supplied via the first and second support paths 1610 and 1620 from leaking to the oil pressure control unit 1200.

When braking is intended to be released in the second fallback mode, the second electronic control unit ECU2 opens first and second discharge valves 1631 and 1641 provided in the first and second dump paths 1630 and 1640, respectively. to discharge the pressurized media applied to the first and second wheel cylinders 31 and 32 to the reservoir 1900, thereby releasing the braking of the vehicle.

1. An electronic brake system comprising:
a first hydraulic pressure supply device generating hydraulic pressure by means of an electric signal output in response to a displacement of a brake pedal;
an oil pressure control unit including a first oil pressure circuit controlling the hydraulic pressure of a first wheel cylinder and a second wheel cylinder and a second oil pressure circuit controlling the hydraulic pressure of a third wheel cylinder and a fourth wheel cylinder;
a second hydraulic pressure supply device connected between the first and second wheel cylinders, and the first oil pressure circuit, and generating the hydraulic pressure by means of the electric signal when at least any one of the first hydraulic pressure supply device and the oil pressure control unit malfunctions;
a main hydraulic path connecting the first hydraulic pressure supply device and the oil pressure control unit; and
a main isolation valve provided in the main hydraulic path and controlling a flow of a pressurized medium, but closed in a first fallback mode in which the first hydraulic pressure supply device malfunctions and the oil pressure control unit is enabled to operate normally to prevent the hydraulic pressure of the pressurized medium provided from the second hydraulic pressure supply device from leaking to the first hydraulic pressure supply device.

2. The electronic brake system of claim 1, wherein the first oil pressure circuit includes first and second inlet paths branched and connected to the first and second wheel cylinders, respectively, from a downstream of the main hydraulic path, and first and second inlet valves provided in the first and second inlet paths, respectively, and controlling the flow of the pressurized medium, and
the second hydraulic pressure supply device is connected to at least any one of the first inlet path and the second inlet path.

3. The electronic brake system of claim 2, wherein the second oil pressure circuit includes third and fourth inlet paths branched and connected to the third and fourth wheel cylinders, respectively, from the downstream of the main hydraulic path, and third and fourth inlet valves provided in the third and fourth inlet paths, respectively, and controlling the flow of the pressurized medium, and
the first to fourth inlet valves are opened in the first fallback mode to transmit the hydraulic pressure of the pressurized medium provided from the second hydraulic pressure supply device to all of the first to fourth wheel cylinders.

4. The electronic brake system of claim 3, further comprising:
a support path connecting at least any one of the first inlet path and the second inlet path, and the second hydraulic pressure supply device; and
a sub isolation valve provided in at least any one of the first inlet path and the second inlet path, but closed in a second fallback mode in which the oil pressure control unit malfunctions to prevent the hydraulic pressure of the pressurized medium provided from the second hydraulic pressure supply device from leaking to the oil pressure control unit.

5. The electronic brake system of claim 3, further comprising:
a first support path connecting the second hydraulic pressure supply device and the first inlet path;
a second support path connecting the second hydraulic pressure supply device and the second inlet path;
a first sub isolation valve provided between a point where the first support path is joined on the first inlet path, and the first inlet valve, and controlling the flow of the pressurized medium, but closed in a second fallback mode in which the oil pressure control unit malfunctions to prevent the hydraulic pressure of the pressurized medium provided from the second hydraulic pressure supply device from leaking to the oil pressure control unit; and
a second sub isolation valve provided between a point where the second support path is joined on the second inlet path, and the second inlet valve, and controlling the flow of the pressurized medium, but closed in the second fallback mode to prevent the hydraulic pressure of the pressurized medium provided from the second hydraulic pressure supply device from leaking to the oil pressure control unit.

6. The electronic brake system of claim 5, further comprising:
a first support valve provided in the first support path and controlling the flow of the pressurized medium; and
a second support valve provided in the second support path and controlling the flow of the pressurized medium.

7. The electronic brake system of claim 3, further comprising:
a reservoir storing the pressurized medium,
wherein the first oil pressure circuit further includes first and second outlet paths connecting the first and second wheel cylinders, and the reservoir, respectively, and first and second outlet valves provided in the first and second outlet paths, respectively, and controlling the flow of the pressurized medium, and
the second oil pressure circuit further includes third and fourth outlet paths connecting the third and fourth wheel cylinders, and the reservoir, respectively, and third and fourth outlet valves provided in the third and fourth outlet paths, respectively, and controlling the flow of the pressurized medium.

8. The electronic brake system of claim 6, further comprising:
a reservoir storing the pressurized medium;
a first dump path connecting the first wheel cylinder and the reservoir; and
a second dump path connecting the second wheel cylinder and the reservoir.

9. The electronic brake system of claim 8, further comprising:
a first discharge valve provided in the first dump path and controlling the flow of the pressurized medium; and
a second discharge valve provided in the second dump path and controlling the flow of the pressurized medium.

10. The electronic brake system of claim 7, further comprising:
a first electronic control unit controlling an operation of at least any one of the first hydraulic pressure supply device, the oil pressure control unit, and the main isolation valve.

11. The electronic brake system of claim 9, further comprising:
a second electronic control unit controlling an operation of at least any one of the second hydraulic pressure supply device, the oil pressure control unit, the main isolation valve, the first and second sub isolation valves, the first and second support valves, and the first and second discharge valves.

12. An operating method of an electronic brake system including a first hydraulic pressure supply device generating hydraulic pressure by means of an electric signal output in response to a displacement of a brake pedal, an oil pressure control unit controlling each of the hydraulic pressures of first to fourth wheel cylinders, and a second hydraulic pressure supply device generating the hydraulic pressure by means of the electric signal when at least any one of the first hydraulic pressure supply device and the oil pressure control unit malfunctions, and connected to at least any one of the first to fourth wheel cylinders, comprising:
a first fallback mode in which the first hydraulic pressure supply device malfunctions, but the oil pressure control unit is enabled to operate normally,
wherein in the first fallback mode, a main isolation valve provided in a main hydraulic path connecting the first hydraulic pressure supply device and the oil pressure control unit, and controlling a flow of a pressurized medium is closed to prevent the hydraulic pressure of the pressurized medium provided from the second hydraulic pressure supply device from leaking to the first hydraulic pressure supply device.

13. The operating method of an electronic brake system of claim 12, wherein the oil pressure control unit includes a first oil pressure circuit controlling the hydraulic pressure of the first wheel cylinder and the second wheel cylinder and a second oil pressure circuit controlling the hydraulic pressure of the third wheel cylinder and the fourth wheel cylinder, and
in the first fallback mode, the hydraulic pressure of the pressurized medium provided from the second hydraulic pressure supply device is transmitted to all of the first to fourth wheel cylinders.

14. The operating method of an electronic brake system of claim 13, wherein the first oil pressure circuit includes first and second inlet paths branched and connected to the first and second wheel cylinders, respectively, from a downstream of the main hydraulic path, and first and second inlet valves provided in the first and second inlet paths, respectively, and controlling the flow of the pressurized medium, and
the second hydraulic pressure supply device is connected to at least any one of the first inlet path and the second inlet path, and transmitting the hydraulic pressure of the pressurized medium.

15. The operating method of an electronic brake system of claim 14, wherein the second oil pressure circuit includes third and fourth inlet paths branched and connected to the third and fourth wheel cylinders, respectively, from the downstream of the main hydraulic path, and third and fourth inlet valves provided in the third and fourth inlet paths, respectively, and controlling the flow of the pressurized medium, and
in the first fallback mode, the first to fourth inlet valves are opened to transmit the hydraulic pressure of the pressurized medium provided from the second hydraulic pressure supply device to all of the first to fourth wheel cylinders.

16. The operating method of an electronic brake system of claim 14, further comprising:
wherein a sub isolation valve is provided in at least any one of the first inlet path and the second inlet path,
a second fallback mode in which the oil pressure control unit malfunctions,
wherein in the second fallback mode, the sub isolation valve is closed to prevent the hydraulic pressure of the pressurized medium provided from the second hydraulic pressure supply device from leaking to the oil pressure control unit.

17. The operating method of an electronic brake system of claim 15, further comprising:
wherein a first sub isolation valve is provided between a point where the second hydraulic pressure supply device is connected on the first inlet path, and the first inlet valve, and a second sub isolation valve is provided between a point where the second hydraulic pressure supply device is connected on the second inlet path, and the second inlet valve,
a second fallback mode in which the oil pressure control unit malfunctions,
wherein in the second fallback mode, the first and second sub isolation valves are closed to prevent the hydraulic pressure of the pressurized medium provided from the second hydraulic pressure supply device from leaking to the oil pressure control unit.

18. The operating method of an electronic brake system of claim 17, wherein a first support valve is provided in a first support path connecting the second hydraulic pressure supply device and the first inlet path, and a second support valve is provided in a second support path connecting the second hydraulic pressure supply device and the second inlet path, and
in the first and second fallback modes, the first and second support valves are opened to allow the flow of the pressurized medium provided from the second hydraulic pressure supply device.

19. The operating method of an electronic brake system of claim 18, further comprising:
a normal mode in which both the first hydraulic pressure supply device and the oil pressure control unit are enabled to operate normally,
wherein in the normal mode, the first and second sub isolation valves are opened to transmit the hydraulic pressure of the pressurized medium provided from the first hydraulic pressure supply device to the first and second wheel cylinders.

20. The operating method of an electronic brake system of claim 19, wherein in the normal mode, the first and second support valves are closed to prevent the hydraulic pressure of the pressurized medium provided from the first hydraulic pressure supply device from leaking to the second hydraulic pressure supply device.
